(19) United States
(12) Patent Application Publication
(10) Pub. No.: US 2013/0263893 A1
(43) Pub. Date: Oct. 10, 2013

(54) Pulse Detonation Combustor Cleaning Device with Divergent Obstacles

(71) Applicants: Tian Xuan Zhang, Raytown, MO (US); David Michael Chapin, Evendale, OH (US); Robert Warren Taylor, Ponte Vedra Beach, FL (US); Miles Alan Peregoy, Raytown, MO (US)

(72) Inventors: Tian Xuan Zhang, Raytown, MO (US); David Michael Chapin, Evendale, OH (US); Robert Warren Taylor, Ponte Vedra Beach, FL (US); Miles Alan Peregoy, Raytown, MO (US)

(73) Assignee: GENERAL ELECTRIC COMPANY, Schenectady, NY (US)

(21) Appl. No.: 13/438,923

(22) Filed: Apr. 4, 2012

(51) Int. Cl. F28G 11/00; B08B 7/02; F22B 37/48

(52) U.S. Cl. 134/17; 122/379; 431/3

(57) ABSTRACT

The present application provides a pulse detonation combustor cleaning device. The pulse detonation combustor cleaning device may include a combustion section and one or more combustion tube sections downstream of the combustion section. The combustion tube sections may a divergent shape and a number of divergent obstacles therein.

### TECHNICAL FIELD

The present application and the resultant patent relate generally to pulse detonation combustors and systems and more particularly relate to pulse detonation combustor cleaning devices with divergent obstacles positioned along one or more diverging sections for increase efficiency and power output.

### BACKGROUND OF THE INVENTION

Industrial boilers operate by using a heat source to create steam from water or other type of working fluid. The steam may be used to drive a turbine or other type of load. The heat source may be a combustor that burns a fuel-air mixture therein. Heat may be transferred to the working fluid from the combustor via a heat exchanger. Burning the fuel-air mixture, however, may generate residues on the surfaces of the combustor, the heat exchangers, and the like. Further, the tubes of the heat exchangers and other types of enclosures with the working fluid flowing therethrough also may develop these residues or other deposits therein.

The presence of these residues and other deposits may inhibit the efficient transfer of heat to the working fluid. This reduction in efficiency may be reflected by an increase in the exhaust gas temperature as well as by an increase in the fuel burn rate required to maintain adequate steam production and energy output. Periodic removal of these residues and deposits thus may help to maintain overall system efficiency and performance. Typically, the complete removal of these residues and deposits generally requires the boiler or other type of system to be shut down until the cleaning process is completed.

Pressurized steam, water jets, acoustic waves, mechanical hammering, and other methods having been used to remove these internal residues and deposits while the boiler is shut down. For example, mechanical methods may include different kinds of brushes, headers, and lances to mechanically pass through the tube. Chemical methods may include the use of different types of chemical solutions. Pneumatic/hydraulic methods may use compressed air or high pressure water jets. Vacuum cleaning methods also may be used. Finally, combinations of these methods also are known to be used together.

More recently, detonative combustion devices have been employed for cleaning. Specifically, a pulse detonation combustor external to the boiler, the heat exchanger tubes, or other types of combustion systems may be used to generate a series of detonations or quasi-detonations that may be directed therein. The high speed shockwaves travel through the boiler, the tubes, or otherwise and loosens the deposits from the surfaces therein. The pulse detonation combustor systems generally result in quickly cleaning the surfaces therein. These systems, however, tend to require a large footprint. Moreover, the strength and effectiveness of the shockwave decreases as the wave travels away from the detonation combustor such that there is a limit to the overall cleaning range.

There is thus a desire for cleaning systems and methods that are able to operate quickly to remove internal residues and deposits in boilers, heat exchanger tubes, and the like so as to minimize downtime. Such systems and methods may operate within the existing environment, i.e., the system may be able to fit physically within the existing space restrictions while being able to reach all of the tubes or other surfaces that require cleaning with adequate strength and effectiveness. Thus, stronger and more compact systems are desired.

### SUMMARY OF THE INVENTION

The present application and the resultant patent thus provide a pulse detonation combustor cleaning device. The pulse detonation combustor cleaning device may include a combustion section and one or more combustion tube sections downstream of the combustion section. The combustion tube sections may a divergent shape with a number of divergent obstacles therein.

The present application and the resultant patent further provide a method of operating a pulse detonation combustor cleaning device. The method may include the steps of creating a supersonic or detonative combustion flow in a combustion section, expanding the combustion flow in one or more combustion tube sections with a divergent shape, maintaining the combustion flow to the one or more combustion tube sections with a number of divergent obstacles, and emitting a number of detonation waves.

The present application and the resultant patent further provide a pulse detonation combustor cleaning device. The pulse detonation combustor cleaning device may include a combustion section and a number of combustion tube sections downstream of the combustion section. One or more of the combustion tube sections may include a divergent shape, a number of divergent obstacles therein, and a number of rods extending through the divergent obstacles.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a pulse detonation combustor cleaning device.

FIG. 2 is a schematic diagram of a pulse detonation combustor cleaning device as may be described herein

FIG. 3 is a perspective view of a pulse detonation cleaning device of FIG. 2 with portions shown in section.

FIG. 4 is a perspective view of a portion of a second combustion tube section of the pulse detonation combustor cleaning device of FIG. 2

FIG. 5 is a partial side view of the second combustion tube section of FIG. 4.

FIG. 6 is a perspective view of a portion of a third combustion tube section of the pulse detonation combustor cleaning device of FIG. 2.

FIG. 7 is a partial side view of the third combustion tube section of FIG. 6.

### DETAILED DESCRIPTION

As used herein, the term “pulse detonation combustor” refers to a device or a system that produces both a pressure rise and a velocity increase from the detonation or quasi-detonation of a fuel and an oxidizer. The pulse detonation combustor may be operated in a repeating mode to produce multiple detonations or quasi-detonations within the device. A “detonation” may be a supersonic combustion in which a shock wave is coupled to a combustion zone. The shock may be sustained by the energy release from the combustion zone so as to result in combustion products at a higher pressure than the combustion reactants. A “quasi-detonation” may be a supersonic turbulent combustion process that produces a pressure rise and a velocity increase higher than the pressure rise and the velocity increase produced by a sub-sonic deflagration wave, i.e., detonation and fast flames. For simplicity, the terms “detonation” or “detonation wave” as used herein will include both detonations and quasi-detonations.

Exemplary pulse detonation combustors, some of which will be discussed in further detail below, include an ignition device for igniting a fuel/oxidizer mixture and a detonation chamber in which pressure wave fronts initiated by the combustion coalesce to produce a detonation wave. Each detonation or quasi-detonation may be initiated either by an external ignition source, such as a spark discharge, laser pulse, heat source, or plasma igniter, or by gas dynamic processes such as shock focusing, auto-ignition, or an existing detonation wave from another source (cross-fire ignition). The detonation chamber geometry may allow the pressure increase behind the detonation wave to drive the detonation wave and also to blow the combustion products themselves out an exhaust of the pulse detonation combustor. Other components and other configurations may be used herein.

Various combustion chamber geometries may support detonation formation, including round chambers, tubes, resonating cavities, reflection regions, and annular chambers. Such combustion chamber designs may be of constant or varying cross-section, both in area and shape. Exemplary combustion chambers include cylindrical tubes and tubes having polygonal cross-sections, such as, for example, hexagonal tubes. As used herein, “downstream” refers to a direction of flow of at least one of the fuel or the oxidizer.

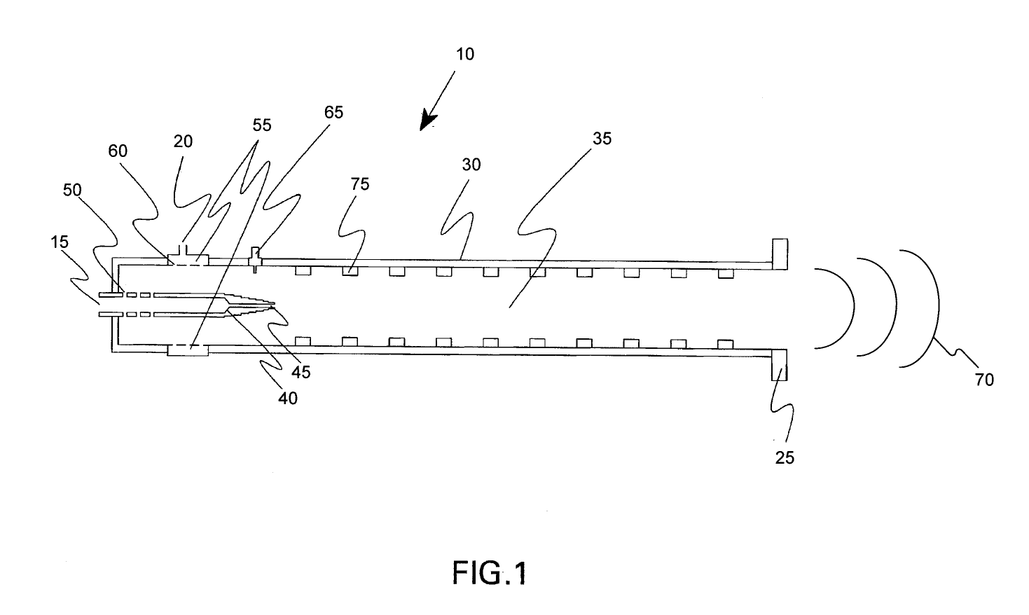

Referring now to the drawings in which like numerals refer to like elements throughout the several views, FIG. 1 shows a generalized example of a pulse detonation combustor cleaning device 10 as may be described herein. The pulse detonation combustor cleaning device 10 may extend from a head end with an air inlet 15 and one or more fuel inlets 20 to an opposed downstream end with an exit nozzle 25. A combustion tube 30 may extend from the head end to the exit nozzle 25 at the downstream end. The combustion tube 30 defines a combustion zone 35 therein. Other components and other configurations may be used herein for detonation and/or quasi-detonation.

The air inlet 15 may be connected to a source of pressurized air such a compressor. The pressurized air may be used to fill and purge the combustion zone 35 and also may serve as an oxidizer for the combustion of the fuel. The air inlet 15 may be in communication with a center body 40. The center body 40 may be in the form of a generally cylindrical tube that extends from the air inlet 15 and then tapers to a downstream opening 45 towards the combustion zone 35. The center body 40 may include one or more air holes 50 along its length. Likewise, the fuel inlet 20 may be connected to a supply fuel that may be burned within the combustion zone 35. The fuel inlet 20 may lead to a fuel plenum 55 with a number of fuel holes 60. The fuel may be injected into the combustion zone 35 so as to mix with the air flow coming through the air holes 50 of the center body 40. The mixing of the fuel and air may be enhanced by the relative arrangement of the fuel holes 60 and the air holes 50 and the overall configuration of the combustion zone 35.

An ignition device 65 may be positioned downstream of the air inlet 15 and the fuel inlet 20. The ignition device 65 may be connected to a controller as to operate the ignition device 65 at desired times and sequences as well as providing feedback signals to monitor overall operations. The fuel and the air may be ignited by the ignition device 65 into a combustion flow so as to produce any number of resultant detonation waves 70. Other components and other configurations also may be used herein.

The combustion tube 30 may include a number of obstacles 75 disposed at various locations along the length thereof The obstacles 75 may take the form of ribs, indents, pins, or any structure. The obstacles 75 may be uniform or random in size, shape, and/or position. The obstacles 75 may be used to enhance the combustion process as it progresses along the length of the tube 30 and to accelerate and propagate the combustion front into the detonation waves 70 before the combustion front reaches the exit nozzle 25.

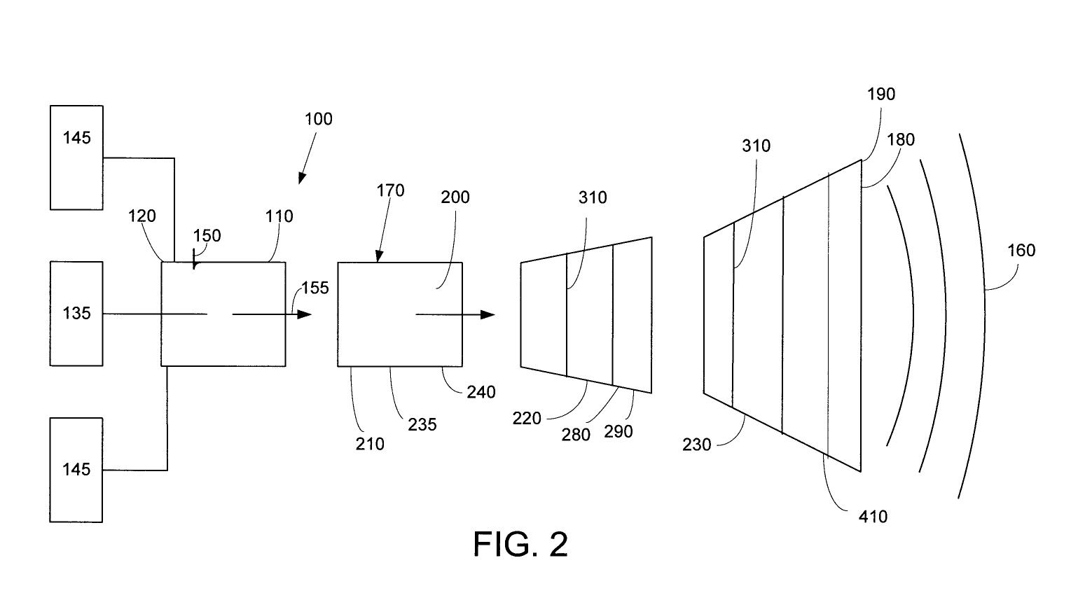

FIG. 2 shows a pulse detonation combustor cleaning device 100 as may be described herein. Similar to that described above, the pulse detonation combustor cleaning device 100 may include a combustion section 110 at a head end 120 thereof The combustion section 110 may include an air inlet 130 in communication with an air source 135 and one or more fuel inlets 140 in communication with one or more fuel sources 145. The fuel sources 145 may include ethylene, propane, methane/natural gas, or other fuels. The combustion section 110 also may include an ignition device 150 positioned about the air inlet 130 and the fuel inlets 140. The fuel and the air may be ignited by the ignition device 150 into a supersonic and/or detonative combustion flow 155 so as to produce the resultant detonation waves 160. Other types of combustion sections 110 may be used herein. Other components and other configurations may be used herein.

The pulse detonation combustor cleaning device 100 also may include one or more combustion tube sections 170. The combustion tube sections 170 may extend from the combustion section 110 at the head end and extend towards an exit nozzle 180 at a downstream end 190. The combustion tube sections 170 define a combustion zone 200 therein.

In this example, the combustion tube sections 170 include three (3) sections: a first section 210, a second section 220, and a third section 230. Although the three (3) sections 170 are shown, any number of the sections 170 may be used herein. Likewise, the sections 170 may be a single element. Other components and other configurations may be used herein.

The first section 210 may extend downstream of the combustion section 110. The first section 210 may be a tube 235 with a substantially cylindrical shape 240 and with a substantially constant diameter. The first section 210 may have any length or diameter. A number of first section obstacles 250 may be positioned within the first section 210. In this example, the first section obstacles 250 may take the form of a number of pins 260. The pins 260 may extend substantially in both the Y and Z directions (with the X direction extending along the length of the section) or in any other direction. The first section obstacles 250 also may take the form of ribs, indents, bars, or any structure. The first section obstacles 250 may be uniform or random in size, shape, or position. The first section obstacles 250 may include features that are machined into the tube 235, formed integrally with the tube 235 (by casting or forging, and the like) or attached to the tube 235 (by welding and the like). Other types of manufacturing techniques may be used herein. Any number of the first section obstacles 250 may be used herein. The tube 235 of the first section 210 may end about a first section joint 270. Other components and other configurations also may be used herein.

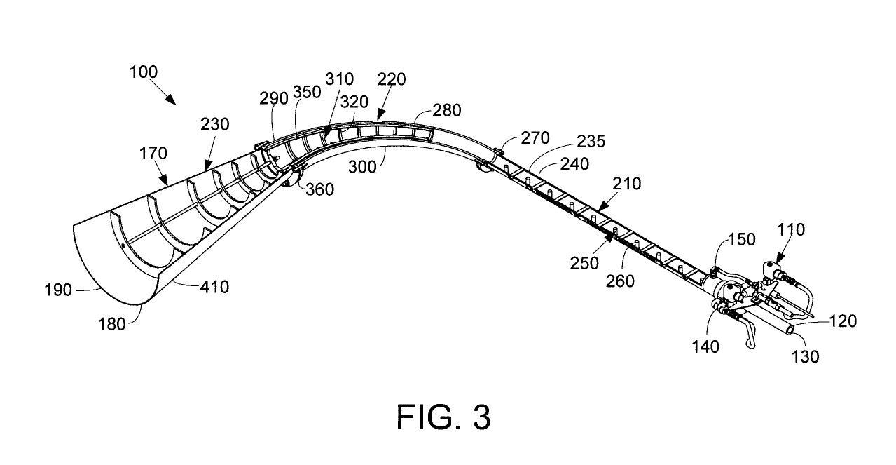

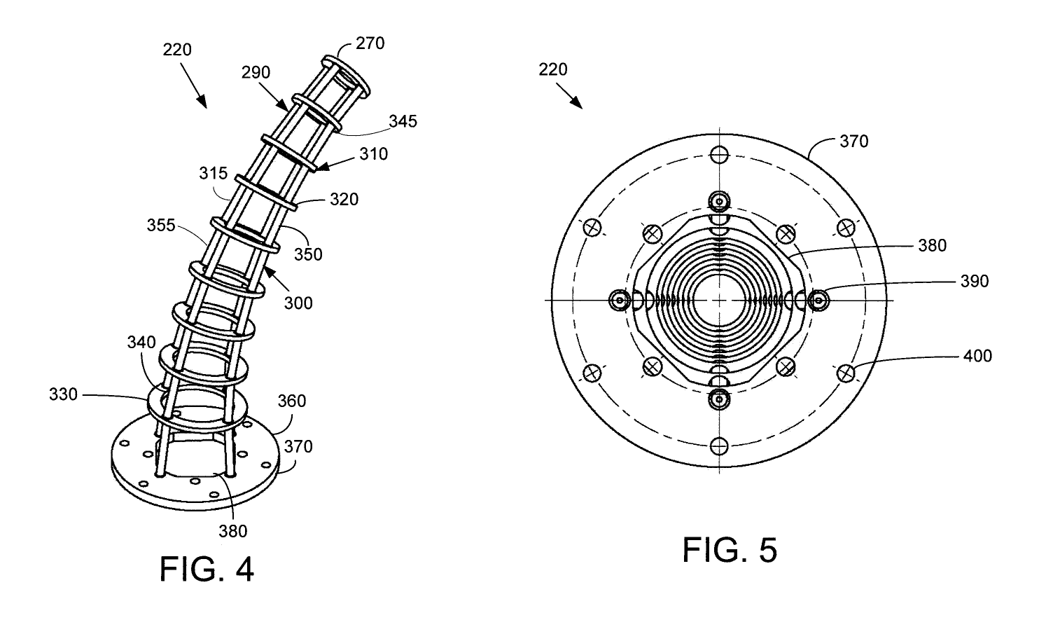

FIGS. 3-5 show various views of the second section 220. The second section 220 may take the form of a tube 280 with a substantially conical or divergent shape 290. The divergent shape 290 may expand in diameter from the first section 210 towards the third section 230. The extent of the increase in diameter may vary. The second section 220 also may include a substantially curved shape 300. The nature of the curved shape 300 may vary. Any type of curved shape 300 may be used herein. The curved shape 300 may assist in positioning the pulse detonation combustor cleaning device 100 in the appropriate location for the cleaning process.

The second section 220 may include a number of divergent obstacles 310 positioned therein. In this example, the divergent obstacles 310 may include a series of rings 320 attached to or adjacent to the tube 280. The rings 320 may increase in both an inside diameter 330 and an outside diameter 340 along the length of the second section 220 from the first section 210 to the third section 230. Although a circular shape is shown, the divergent obstacles 310 may have any size, shape, or configuration including half circles and other types of partial shapes with gaps and the like therein. Any number of divergent obstacles 310 may be used herein. The divergent obstacles 310 may be formed integrally with the tube 280 or the divergent obstacles 310 may be attached thereto as an obstacle insert 315. The obstacle insert 315 may be removable and replaceable. Likewise, the divergent obstacles 310 may be in contact with the tube and/or a gap may be positioned therebetween.

The divergent obstacles 310 may be supported by a number of rods 350. The rods 350 may extend along the length of the tube 280 and through one or more obstacle apertures 345 in each ring 320. Although four (4) rods 350 are shown, any number of the rods 350 may be used. The rods 350 may take the form of a number of segments 355 so as to accommodate the substantially conical or divergent shape 290 and the substantially curved shape 300 of the tube 280.

The second section 220 may extend towards a second section joint plate 360. The second section joint plate 360 may have a plate aperture 370 therein. In this example, the plate aperture 370 may have a substantially octagonal shape 380. Other shapes and other configurations may be used herein. The second section joint plate 360 also may have a number of second section rod apertures 390 for the rods 350 extending through the second section 220 as well as a number of third section rod apertures 400 for the rods 350 extending through the third section 230. Other components and other configurations may be used herein.

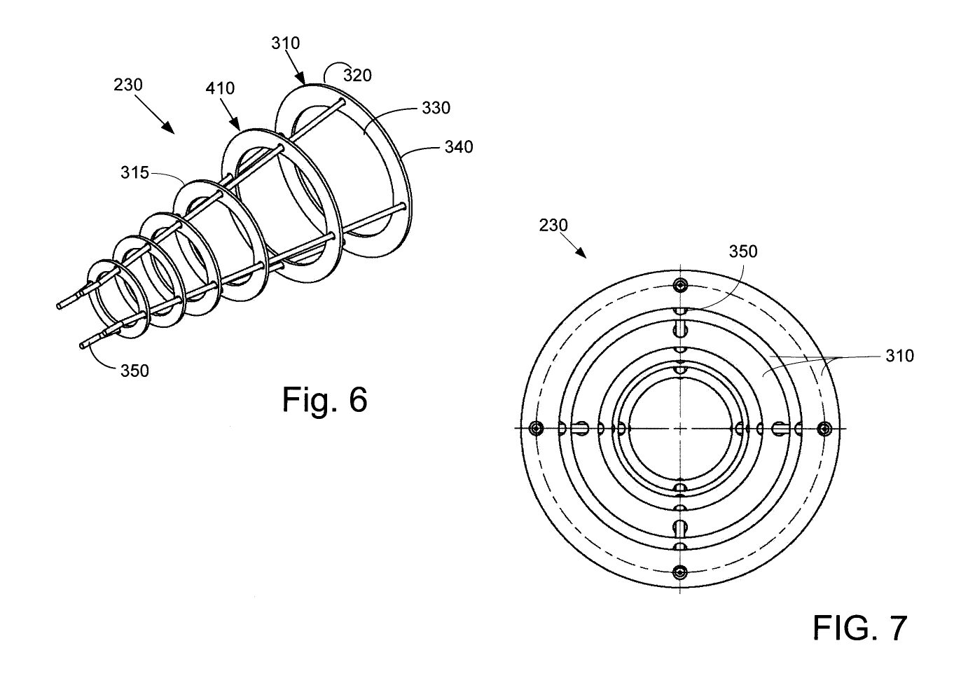

FIGS. 6 and 7 show an example of the third section 230. The third section 230 may extend from the second section 220 to the exit nozzle 180. The third section 230 also may include a tube 410 with a substantial conical or divergent shape 420. The third section 230 expands in diameter from the second section 220 to the exit nozzle 180. The third section 230 may be substantially straight as is shown, or the third section 230 may have a substantially curved shape. Any type of curve may be used herein. The third section 230 may include the divergent obstacles 310 in the form of the rings 320. The rings 320 may be stabilized with the rods 350. The rods 350 may extend from the second section plate aperture 370 to the final ring 320. As described above, the divergent obstacles 310 may be formed integrally with the tube 280 or the divergent obstacles 310 and the rods 350 may be attached thereto as the obstacle insert 315. The obstacle insert 315 may be removable and replaceable. Other components and other configurations may be used herein.

The use of the divergent obstacles 310 herein thus may provide the pulse detonation combustor cleaning device 100 with a much lower “blockage ratio” as compared to known devices, i.e., the ratio of the blocked area of a tube resulting from the obstacles to the area of the tube, so as to maintain the detonation waves 160 propagating therein. Specifically, the blockage ratio may decline from about sixty percent (60%) at the beginning of the second section 220 to about forty percent (40%) at the end of the third section 230. This variable ratio thus indicates that the combustion zone 200 opens up in area in a downstream direction.

In use, the flows of gas and air are ignited within the combustion section 110. The supersonic and/or detonative combustion gases 155 generate the detonation waves 160 that travel through the combustion zone 200 in the combustion tube sections 170. Given the divergent shape 290 in the second section 220 and the divergent shape 420 in the third section 230, the divergent obstacles 310 help to maintain the detonation waves 160 coupled therein. By increasing the diameter of the detonation waves 160 without decoupling the combustion front from the shock wave, the overall strength of the detonation waves 160 may be increased so as to increase the overall power of the pulsed detonation combustor cleaning device 100 described herein.

Increasing the power thus increases the ability of the pulse detonation combustor cleaning device 100 to clean as well as increases the ability to use multiple fuels herein. The configuration shown herein allows such to occur while maintaining a very compact size of the overall pulse detonation combustor cleaning device 100. A combustion chamber of uniform and equivalent diameter to the exit diameter of the cleaning device described herein would need to be several times longer in length to achieve a similar detonation.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A pulse detonation combustor cleaning device, comprising:
a combustion section; and
one or more combustion tube sections downstream of the combustion section;
wherein the one or more combustion tube sections comprise a divergent shape with a plurality of divergent obstacles therein.

2. The pulse detonation combustor cleaning device of claim 1, wherein the combustion section comprises an air inlet, a fuel inlet, and an ignition device.

3. The pulse detonation combustor cleaning device of claim 1, wherein the one or more combustion tube sections comprise a combustion zone therein.

4. The pulse detonation combustor cleaning device of claim 1, wherein the one or more combustion tube sections comprise a first combustion tube section.

5. The pulse detonation combustor cleaning device of claim 4, wherein the first combustion tube section comprises a substantially cylindrical shape.

6. The pulse detonation combustion cleaning device of claim 4, wherein the first combustion tube section comprises a plurality of first section obstacles therein.

7. The pulse detonation combustion cleaning device of claim 1, wherein the one or more combustion tube sections comprise a second tube section.

8. The pulse detonation combustor cleaning device of claim 7, wherein the second tube section comprises the divergent shape.

9. The pulse detonation combustor cleaning device of claim 7, wherein the second tube section comprises a curved shape.

10. The pulse detonation combustor cleaning device of claim 1, wherein the one or more combustion tube sections comprise a third tube section.

11. The pulse detonation combustor cleaning device of claim 10, wherein the third tube section comprises the divergent shape.

12. The pulse detonation combustor cleaning device of claim 1, wherein the plurality of divergent obstacles comprises a plurality of rings.

13. The pulse detonation combustor cleaning device of claim 1, wherein the plurality of divergent obstacles comprises an obstacle insert.

14. The pulse detonation combustor cleaning device of claim 1, further comprising a plurality of rods extending through the plurality of divergent obstacles.

15. A method of operating a pulse detonation combustor cleaning device, comprising:
creating a supersonic or detonative combustion flow in a combustion section;
expanding the combustion flow in one or more combustion tube sections with a divergent shape;
maintaining the combustion flow within the one or more combustion tube sections with a plurality of divergent obstacles; and
emitting a plurality of detonation waves.

16. A pulse detonation combustor cleaning device, comprising:
a combustion section; and
a plurality combustion tube sections downstream of the combustion section;
wherein one or more of the plurality of combustion tube sections comprise a divergent shape; and
wherein the one or more combustion tube sections comprise a plurality of divergent obstacles therein and a plurality of rods extending through the plurality of divergent obstacles.

17. The pulse detonation combustor cleaning device of claim 16, wherein the combustion section comprises an air inlet, a fuel inlet, and an ignition device.

18. The pulse detonation combustor cleaning device of claim 16, wherein the one or more combustion tube sections comprise a combustion zone therein.

19. The pulse detonation combustor cleaning device of claim 16, wherein one or more of the plurality of combustion tube sections comprise a curved shape.

20. The pulse detonation combustor cleaning device of claim 16, wherein the plurality of divergent obstacles comprises a plurality of rings.
